(19) United States
(12) Patent Application Publication
(10) Pub. No.: US 2026/0362538 A1
(43) Pub. Date: Nov. 12, 2026

(54) METHOD AND APPARATUS FOR DYNAMIC ADAPTATION OF DISCONTINUOUS RECEPTION CONFIGURATION

(71) Applicant: Lenovo (Beijing) Limited, Beijing (CN)

(72) Inventors: Yingying Li, Beijing (CN); Hongmei Liu, Beijing (CN); Yuantao Zhang, Beijing (CN); Haiming Wang, Beijing (CN); Zhi Yan, Beijing (CN)

(73) Assignee: Lenovo (Beijing) Limited, Beijing (CN)

(21) Appl. No.: 19/102,955

(22) PCT Filed: Aug. 12, 2022
(86) PCT No.: PCT/CN2022/112110

§ 371 Date: Feb. 11, 2025

(51) Int. Cl. H04W 76/28; H04W 72/23

(52) U.S. Cl. CPC H04W 76/28; H04W 72/23

(57) ABSTRACT

Embodiments of the present disclosure relate to methods and apparatuses for dynamic adaptation of a DRX configuration. According to some embodiments of the disclosure, a UE may: receive a first configuration of DRX, wherein the first configuration may include at least one of: a first value for a DRX on-duration timer, a first DRX slot offset, a first DRX start offset, or a first DRX cycle; receive a second configuration including DRX associated information; and monitor a PDCCH discontinuously based on the first configuration and the second configuration.

### TECHNICAL FIELD

Embodiments of the present disclosure generally relate to wireless communication technology, and more particularly to dynamic adaptation of discontinuous reception (DRX) configurations.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long-term evolution (LTE) systems, LTE-advanced (LTE-A) systems, or LTE-A Pro systems, and fifth generation (5G) systems, which may also be referred to as new radio (NR) systems.

In a wireless communication system, a user equipment (UE) may use discontinuous reception (DRX) to reduce power consumption. The DRX can work in a radio resource control (RRC) connected mode and an RRC idle mode, which may be referred to as C-DRX (i.e., connected mode DRX) and idle mode DRX, respectively. C-DRX may include two types of DRX cycles, i.e., short DRX cycle and long DRX cycle. The short DRX cycle may be optional.

There is a need for improving the DRX mechanism in a communication system.

### SUMMARY

Some embodiments of the present disclosure provide a user equipment (UE). The UE may include a transceiver, and a processor coupled to the transceiver. The processor may be configured to: receive a first configuration of discontinuous reception (DRX), wherein the first configuration may include at least one of: a first value for a DRX on-duration timer, a first DRX slot offset, a first DRX start offset, or a first DRX cycle; receive a second configuration including DRX associated information; and monitor a physical downlink control channel (PDCCH) discontinuously based on the first configuration and the second configuration.

In some embodiments of the present disclosure, the DRX associated information may indicate at least one of: a set of offsets or a set of values for a maximum on-duration timer, wherein each offset in the set of offsets is associated with a corresponding set of DRX cycles, and wherein each value in the set of values for the maximum on-duration timer is associated with the corresponding set of DRX cycles.

In some embodiments of the present disclosure, the set of offsets may include a set of start offsets or a set of combinations of a start offset and a slot offset.

In some embodiments of the present disclosure, the processor may be further configured to: in response to the first DRX cycle is in a set of DRX cycles associated with a first offset in the set of offsets, or the first DRX cycle is a multiple of a DRX cycle in the set of DRX cycles associated with the first offset, or a DRX cycle in the set of DRX cycles associated with the first offset is a multiple of the first DRX cycle, determine a second DRX start offset, a second DRX slot offset, or both for monitoring the PDCCH based on the first offset.

In some embodiments of the present disclosure, the DRX associated information may indicate at least one of: a second DRX cycle, a second value for a maximum on-duration timer, a second DRX start offset, or a second DRX slot offset.

In some embodiments of the present disclosure, the processor may be further configured to determine a third DRX cycle for monitoring the PDCCH based on the second DRX cycle, or based on the first DRX cycle and the second DRX cycle.

In some embodiments of the present disclosure, the third DRX cycle may be determined based on a scaling factor and the second DRX cycle, and the scaling factor is based on the first DRX cycle and the second DRX cycle.

In some embodiments of the present disclosure, the processor may be further configured to determine a starting position of the DRX on-duration timer based on the first or third DRX cycle, the second DRX start offset, and one of the first DRX slot offset and the second DRX slot offset.

In some embodiments of the present disclosure, the processor may be further configured to determine a starting position of the maximum on-duration timer based on the first or third DRX cycle, the second DRX start offset, and one of the first DRX slot offset and the second DRX slot offset; and determine a starting position of the DRX on-duration timer after an offset from the starting position of the maximum on-duration timer. The offset may be based on a scaling factor and the first DRX start offset. In some examples, the scaling factor is based on the first DRX cycle and one of a first maximum on-duration timer value in the set of values for the maximum on-duration timer or the second value for a maximum on-duration timer, wherein the first maximum on-duration timer value is associated with the set of DRX cycles associated with the first offset. In some examples, the scaling factor is based on the first DRX cycle, the first value for the DRX on-duration timer, and one of the first maximum on-duration timer value and the second value for a maximum on-duration timer.

In some embodiments of the present disclosure, the processor may be further configured to: determine a starting position of a DRX cycle based on the first or third DRX cycle, the second DRX start offset, and one of the first DRX slot offset and the second DRX slot offset; and determine a starting position of the DRX on-duration timer after an offset from the starting position of the DRX cycle. The offset may be based on an ID of the UE and the first value for the DRX on-duration timer.

In some embodiments of the present disclosure, the processor may be further configured to determine a starting position of the DRX on-duration timer in the first DRX cycle based on a reference starting position determined based on the second configuration in the first DRX cycle. In the case that there are a plurality of reference starting positions in the first DRX cycle, the earliest reference starting position of the plurality of reference starting positions may be used for determining the starting position of the DRX on-duration timer.

In some embodiments of the present disclosure, the processor may be further configured to determine an on-duration in the first DRX cycle for monitoring the PDCCH based on an intersection of an on-duration determined based on the first configuration and an on-duration determined based on the second configuration.

In some embodiments of the present disclosure, the DRX associated information may include a periodicity of a synchronization signal block (SSB). Monitoring the PDCCH may include monitoring the PDCCH according to a third DRX cycle associated with the periodicity of the SSB.

In some embodiments of the present disclosure, a DRX on-duration timer in the third DRX cycle is associated with a time duration for reception of a synchronization signal (SS) burst set(s). In some embodiments of the present disclosure, a DRX on-duration timer in the third DRX cycle is associated with a time duration for reception of an SS burst(s) associated with the same beam as the UE.

In some embodiments of the present disclosure, the third DRX cycle is equal to the periodicity of the SSB, or the third DRX cycle is a multiple of the periodicity of the SSB, or the third DRX cycle is based on a scaling factor and the periodicity of the SSB. The scaling factor may be based on the first DRX cycle and the periodicity of the SSB.

In some embodiments of the present disclosure, monitoring the PDCCH discontinuously based on the first configuration and the second configuration may include one of the following: monitoring the PDCCH discontinuously based on the first configuration and the second configuration in response to receiving the second configuration; or monitoring the PDCCH discontinuously based on the first configuration and the second configuration in response to receiving an indication to activate the second configuration.

Some embodiments of the present disclosure provide a base station (BS). The BS may include a transceiver, and a processor coupled to the transceiver. The processor may be configured to: transmit a first configuration of discontinuous reception (DRX), wherein the first configuration may include at least one of: a first value for a DRX on-duration timer, a first DRX slot offset, a first DRX start offset, or a first DRX cycle; transmit a second configuration including DRX associated information; and transmit a physical downlink control channel (PDCCH) discontinuously based on the first configuration and the second configuration.

In some embodiments of the present disclosure, the DRX associated information may indicate at least one of: a set of offsets or a set of values for a maximum on-duration timer, wherein each offset in the set of offsets is associated with a corresponding set of DRX cycles, and wherein each value in the set of values for the maximum on-duration timer is associated with the corresponding set of DRX cycles.

In some embodiments of the present disclosure, the set of offsets may include a set of start offsets or a set of combinations of a start offset and a slot offset.

In some embodiments of the present disclosure, the processor may be further configured to: in response to the first DRX cycle is in a set of DRX cycles associated with a first offset in the set of offsets, or the first DRX cycle is a multiple of a DRX cycle in the set of DRX cycles associated with the first offset, or a DRX cycle in the set of DRX cycles associated with the first offset is a multiple of the first DRX cycle, determine a second DRX start offset, a second DRX slot offset, or both for transmitting the PDCCH based on the first offset.

In some embodiments of the present disclosure, the DRX associated information may indicate at least one of: a second DRX cycle, a second value for a maximum on-duration timer, a second DRX start offset, or a second DRX slot offset.

In some embodiments of the present disclosure, the processor may be further configured to determine a third DRX cycle for transmitting the PDCCH based on the second DRX cycle, or based on the first DRX cycle and the second DRX cycle.

In some embodiments of the present disclosure, the third DRX cycle may be determined based on a scaling factor and the second DRX cycle, and the scaling factor is based on the first DRX cycle and the second DRX cycle.

In some embodiments of the present disclosure, the processor may be further configured to determine a starting position of the DRX on-duration timer based on the first or third DRX cycle, the second DRX start offset, and one of the first DRX slot offset and the second DRX slot offset.

In some embodiments of the present disclosure, the processor may be further configured to: determine a starting position of the maximum on-duration timer based on the first or third DRX cycle, the second DRX start offset, and one of the first DRX slot offset and the second DRX slot offset; and determine a starting position of the DRX on-duration timer after an offset from the starting position of the maximum on-duration timer. The offset may be based on a scaling factor and the first DRX start offset. In some examples, the scaling factor is based on the first DRX cycle and one of a first maximum on-duration timer value in the set of values for the maximum on-duration timer or the second value for a maximum on-duration timer, wherein the first maximum on-duration timer value is associated with the set of DRX cycles associated with the first offset. In some examples, the scaling factor is based on the first DRX cycle, the first value for the DRX on-duration timer, and one of the first maximum on-duration timer value and the second value for a maximum on-duration timer.

In some embodiments of the present disclosure, the processor may be further configured to: determine a starting position of a DRX cycle based on the first or third DRX cycle, the second DRX start offset, and one of the first DRX slot offset and the second DRX slot offset; and determine a starting position of the DRX on-duration timer after an offset from the starting position of the DRX cycle. The offset may be based on an ID of the UE and the first value for the DRX on-duration timer.

In some embodiments of the present disclosure, the processor may be further configured to determine a starting position of the DRX on-duration timer in the first DRX cycle based on a reference starting position determined based on the second configuration in the first DRX cycle. In the case that there are a plurality of reference starting positions in the first DRX cycle, the earliest reference starting position of the plurality of reference starting positions is used for determining the starting position of the DRX on-duration timer.

In some embodiments of the present disclosure, the processor may be further configured to determine an on-duration in the first DRX cycle for transmitting the PDCCH based on an intersection of an on-duration determined based on the first configuration and an on-duration determined based on the second configuration.

In some embodiments of the present disclosure, the DRX associated information may include a periodicity of a synchronization signal block (SSB). Transmitting the PDCCH may include transmitting the PDCCH according to a third DRX cycle associated with the periodicity of the SSB.

In some embodiments of the present disclosure, a DRX on-duration timer in the third DRX cycle is associated with a time duration for reception of a synchronization signal (SS) burst set(s). In some embodiments of the present disclosure, a DRX on-duration timer in the third DRX cycle is associated with a time duration for reception of an SS burst(s) associated with the same beam as the UE.

In some embodiments of the present disclosure, the third DRX cycle is equal to the periodicity of the SSB, or the third DRX cycle is a multiple of the periodicity of the SSB, or the third DRX cycle is based on a scaling factor and the periodicity of the SSB. The scaling factor may be based on the first DRX cycle and the periodicity of the SSB.

In some embodiments of the present disclosure, transmitting the PDCCH discontinuously based on the first configuration and the second configuration may include one of the following: transmitting the PDCCH discontinuously based on the first configuration and the second configuration in response to transmitting the second configuration; or transmitting an indication to activate the second configuration, and transmitting the PDCCH discontinuously based on the first configuration and the second configuration in response to transmitting the indication.

Some embodiments of the present disclosure provide a method for wireless communication performed by a UE. The method may include: receiving a first configuration of discontinuous reception (DRX), wherein the first configuration may include at least one of: a first value for a DRX on-duration timer, a first DRX slot offset, a first DRX start offset, or a first DRX cycle; receiving a second configuration including DRX associated information; and monitoring a physical downlink control channel (PDCCH) discontinuously based on the first configuration and the second configuration.

Some embodiments of the present disclosure provide a method for wireless communication performed by a BS. The method may include: transmitting a first configuration of discontinuous reception (DRX), wherein the first configuration may include at least one of: a first value for a DRX on-duration timer, a first DRX slot offset, a first DRX start offset, or a first DRX cycle; transmitting a second configuration including DRX associated information; and transmitting a physical downlink control channel (PDCCH) discontinuously based on the first configuration and the second configuration.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2 and 3 illustrate general schematic diagrams of DRX in accordance with some embodiments of the present disclosure;

FIGS. 4-12 illustrate schematic diagrams for dynamic adaptation of a DRX configuration in accordance with some embodiments of the present disclosure;

FIGS. 13 and 14 illustrate flow charts of exemplary procedures of wireless communications in accordance with some embodiments of the present disclosure; and

FIG. 15 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

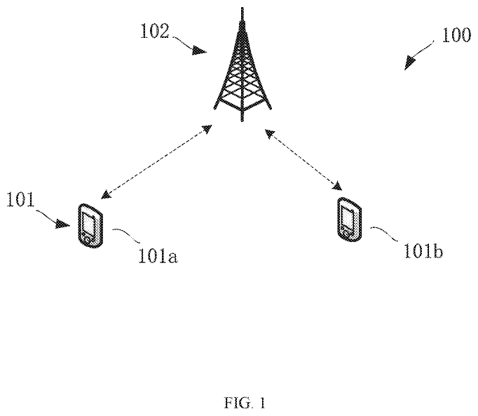

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographical region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In some embodiments of the present disclosure, when in a connected mode (e.g., RRC_CONNECTED state as specified in 3GPP specifications), a UE may be configured to use a C-DRX in which the UE may periodically wake up and monitor a PDCCH during an active period (e.g., an on duration) and enter a sleep mode during an inactive period, thereby conserving power. The sleep mode here means that the UE may have an opportunity for DRX to skip monitoring a PDCCH; however, the UE may monitor other channels or signals.

For example, the RRC may control the DRX operations by configuring various parameters including at least one of the following: a DRX on-duration timer (e.g., drx-onDurationTimer as specified in 3GPP specifications), a DRX slot offset (drx-SlotOffset as specified in 3GPP specifications), a DRX start offset (e.g., drx-StartOffset as specified in 3GPP specifications), a long cycle (e.g., drx-LongCycle as specified in 3GPP specifications), a short cycle (e.g., drx-ShortCycle as specified in 3GPP specifications), or a DRX inactivity timer (e.g., drx-InactivityTimer as specified in 3GPP specifications). In some embodiments of the present disclosure, the above DRX configuration may be configured via a UE-specific RRC message. It should be noted that the RRC may not separately configure the parameters drx-StartOffset and drx-LongCycle, but may configure the parameters drx-StartOffset and drx-LongCycle a parameter in drx-LongCycleStartOffset in some embodiments. That is, the parameter drx-LongCycleStartOffset may include both the DRX start offset and the long cycle.

A UE may determine the starting subframe number of a DRX cycle if the system frame number (denoted as “SFN”) and the subframe number (denoted as “subframe number”) satisfy: [(SFN×10)+subframe number] modulo (drx-ShortCycle)=(drx-StartOffset) modulo (drx-ShortCycle) for short DRX cycle; or [(SFN×10)+subframe number] modulo (drx-LongCycle)=drx-StartOffset for long DRX cycle, wherein “drx-ShortCycle”, “drx-LongCycle” and “drx-StartOffset” depend on the RRC configurations as mentioned above. In the context of the present disclosure, it is assumed that a radio frame includes 10 subframes.

In some embodiments, after the UE determines the starting subframe number, a delay before starting the DRX on-duration timer may be determined by a DRX slot offset. Therefore, the starting position of the DRX on-duration timer may be determined by the DRX cycle (e.g., the DRX short or long cycle), the DRX start offset and the DRX slot offset. In some other embodiments, such delay may not exist.

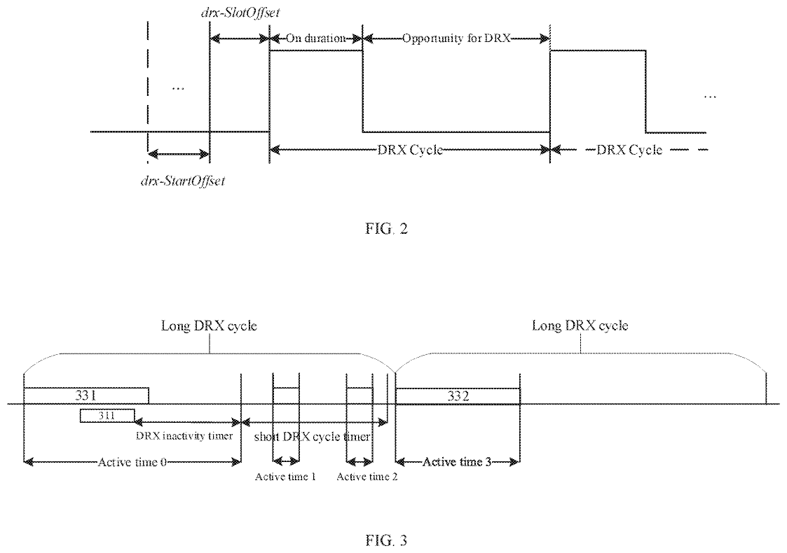

FIG. 2 illustrates a general schematic diagram of DRX in accordance with some embodiments of the present disclosure.

As shown in FIG. 2, a UE may determine the starting position of its on-duration based on a DRX slot offset (denoted as “drx-SlotOffset” in FIG. 2) and a DRX start offset (denoted as “drx-startOffset” in FIG. 2). The UE may monitor a PDCCH in the “on duration” as shown in FIG. 2. The duration of the “on duration” may be determined by a DRX on-duration timer. For example, the two edges of the “on duration” as shown in FIG. 2 may represent the start of the DRX on-duration timer and the expiry of the DRX on-duration timer, respectively. In the example of FIG. 2, the UE does not receive a PDCCH in the on duration. In response to the expiry of the DRX on-duration timer, the UE may enter a sleep mode whereby the UE may have an opportunity for the DRX to skip monitoring the PDCCH.

A UE may be configured with a long DRX cycle and a short DRX cycle. The short DRX cycle may be optional. The exemplary configurations of a long DRX cycle and short DRX cycle are shown below.

| | |
|---|---|
| drx-LongCycleStartOffset | CHOICE { |
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239), |
| } | |

| | |
|---|---|
| drx-ShortCycle | ENUMERATED { |
| | ms2, ms3, ms4, ms5, ms6, ms7, ms8, ms10, ms14, ms16, ms20, ms30, |

ms32,

ms35, ms40, ms64, ms80, ms128, ms160, ms256, ms320, ms512, ms640,

spare9,

spare8, spare7, spare6, spare5, spare4, spare3, spare2, spare1 },

}

In some embodiments of the present disclosure, when a DRX is configured, the active time for serving cells in a DRX group may include the time while at least one of the following condition is fulfilled:
a DRX on-duration timer (e.g., drx-onDurationTimer) or a DRX inactivity timer (e.g., drx-InactivityTimer) configured for the DRX group is running;
a DRX retransmission timer (e.g., drx-RetransmissionTimerDL or drx-RetransmissionTimerUL as specified in 3GPP specifications) is running on any serving cell in the DRX group;
a random access contention resolution timer (e.g., ra-ContentionResolutionTimer as specified in 3GPP specifications) or a msgB response window (e.g., msgB-ResponseWindow as specified in 3GPP specifications) is running;
a scheduling request is sent on a physical uplink control channel (PUCCH) and is pending; or
a PDCCH indicating a new transmission addressed to the cell-radio network temporary identifier (C-RNTI) of the media access control (MAC) entity has not been received after a successful reception of a random access response for the random access preamble not selected by the MAC entity among the contention-based random access preamble (as described in 3GPP specifications).

FIG. 3 illustrates a general schematic diagram of DRX in accordance with some embodiments of the present disclosure, in which various examples of active time are shown.

Referring to FIG. 3, a UE may monitor a PDCCH from the start of the on duration (e.g., on-durations 331 and 332 as shown in FIG. 3). In some embodiments, the UE may receive PDCCH 311 in on-duration 331. The UE may start a DRX inactivity timer in response to receiving PDCCH 311 and monitor a PDCCH before the expiry of the DRX inactivity timer. In some embodiments, if the short DRX cycle is configured, the UE may start a short DRX cycle timer (e.g., drx-shortcycletimer as specified in 3GPP specifications) in response to the expiry of the DRX inactivity timer. The UE may monitor a PDCCH based on the short DRX cycle (if configured) before the expiry of the short DRX cycle timer. In the example of FIG. 3, the UE does not receive a PDCCH in on durations in the DRX inactivity timer or the short DRX cycle timer. In response to the expiry of the short DRX cycle timer, the UE may monitor a PDCCH based on the long DRX cycle.

As shown in FIG. 3, active time 0 refers to the time when a DRX on-duration timer (e.g., for the long DRX cycle) or a DRX inactivity timer is running. Active time 1 and active time 2 refer to the time when a DRX on-duration timer (e.g., for the short DRX cycle) is running. Active time 3 refers to the time when a DRX on-duration timer (e.g., for the long DRX cycle) is running.

As shown above, C-DRX functionality can be used to control the UE's PDCCH monitoring activity for UE power saving. The RRC may configure different C-DRX configurations (e.g., offsets) to distribute UEs in time. However, when the system load is low, it would be unnecessary to distribute UEs in time. Aligning C-DRX configurations across multiple UEs would be advantageous. For example, it may facilitate the DTX/DRX implementation at the BS side. For example, it may minimize the BS's active time for network energy saving. For example, it may bring about fewer PDCCH transmissions for a certain DCI format (e.g., DCI format 2_6 as specified in 3GPP specifications).

In some embodiments of the present disclosure, a BS may reconfigure the DRX settings for UEs via UE-specific RRC messages. However, this may bring much signaling overload and the network (e.g., the BS) may miss a sleep chance. Embodiments of the present application provide further enhanced solutions for aligning C-DRX configurations among UEs that can overcome the above drawbacks. For instance, embodiments of the present application provide solutions for dynamic DRX adaption in a more efficient way, for example, in a UE-group or cell-specific manner. How to align the on-durations of the UEs (including, for example, which parameters should be updated, and the method for aligning UEs' on-durations) are discussed. More details on the embodiments of the present disclosure will be illustrated in the following text in combination with the appended drawings.

In some embodiments of the present disclosure, a UE may receive a DRX configuration (denoted as “DRX configuration #1”) from a BS. DRX configuration #1 may include at least one of: a timer value for a DRX on-duration timer, a DRX slot offset, a DRX start offset, or a DRX cycle. The DRX cycle may include a long DRX cycle, a short DRX cycle, or both. DRX configuration #1 may further include a timer value for a DRX inactivity timer.

In some embodiments of the present disclosure, the UE may further receive another configuration (denoted as “DRX configuration #2”) including DRX associated information. The UE may monitor a PDCCH discontinuously based on DRX configuration #1 and DRX configuration #2. For example, in some embodiments, in response to receiving DRX configuration #2, or in response to receiving an indication to activate DRX configuration #2, the UE may monitor the PDCCH discontinuously based on DRX configuration #1 and DRX configuration #2.

On the other hand, from the perspective of the BS, it may transmit a PDCCH discontinuously to the UE based on DRX configuration #1 and DRX configuration #2. For example, in some embodiments, in response to transmitting DRX configuration #2, or in response to transmitting an indication to activate DRX configuration #2, the BS may transmit the PDCCH discontinuously based on DRX configuration #1 and DRX configuration #2.

In some embodiments of the present disclosure, UEs configured with the same DRX cycle, configured with a DRX cycle included in a set of DRX cycles, or configured with DRX cycles with a certain relationship (e.g., a multiple relationship) may share a common offset (e.g., a common start offset, a common slot offset, or both). The common offset may be configured by a BS to a group of UEs, predefined in a standard, or preconfigured. In these embodiments, the DRX cycle (denoted as “DRX cycle #1”) configured in DRX configuration #1 may be applied for discontinuously monitoring the PDCCH.

In some embodiments of the present disclosure, DRX configuration #2 (e.g., the DRX associated information) may indicate at least one of: a set of offsets or a set of values for a maximum on-duration timer. Each offset in the set of offsets may be associated with a corresponding set of DRX cycles. Each value in the set of values for the maximum on-duration timer may be associated with the corresponding set of DRX cycles. The set of offsets may include a set of start offsets or a set of combinations of a start offset and a slot offset. For example, there may be only a start offset(s) in the DRX configuration #2 associated with a corresponding set of DRX cycles or there may be a start offset(s) and a slot offset(s) in the DRX configuration #2 associated with a corresponding set of DRX cycles. That is, the slot offset may be optional.

Various embodiments may be employed for determining the common offset (e.g., a common start offset or both the common start offset and a common slot offset).

In some embodiments of the present disclosure, when DRX cycle #1 is included in a set of DRX cycles associated with a certain offset (e.g., offset #1A) in the set of offsets indicated by DRX configuration #2, the UE may determine an offset (e.g., a DRX start offset, a DRX slot offset, or both) for monitoring the PDCCH based on offset #1A which is associated with the set of DRX cycles including DRX cycle #1. For example, the UE may apply offset #1A as the offset for discontinuously monitoring the PDCCH. For example, if offset #1A is a start offset, the UE may determine that the DRX start offset equals the offset #1A. If offset #1A is a combination of a start offset and a slot offset, the UE may determine that the DRX start offset equals the start offset in offset #1A and determine the DRX slot offset equals the slot offset in offset #1A.

In some embodiments of the present disclosure, when DRX cycle #1 is a multiple of a DRX cycle (e.g., DRX cycle #2A) in a set of DRX cycles associated with a certain offset (e.g., offset #1B) in the set of offsets indicated by DRX configuration #2, the UE may determine an offset (e.g., a DRX start offset, a DRX slot offset, or both) for monitoring the PDCCH based on offset #1B which is associated with DRX cycle #2A in the set of DRX cycles. For example, the UE may apply offset #1B as the offset for discontinuously monitoring the PDCCH.

In some embodiments of the present disclosure, when a DRX cycle (e.g., DRX cycle #2C) in a set of DRX cycles associated with a certain offset (e.g., offset #1C) in the set of offsets indicated by DRX configuration #2 is a multiple of DRX cycle #1, the UE may determine an offset (e.g., a DRX start offset, a DRX slot offset, or both) for monitoring the PDCCH based on offset #1C which is associated with DRX cycle #2C in the set of DRX cycles. For example, the UE may apply offset #1C as the offset for discontinuously monitoring the PDCCH.

In some embodiments, the UE may determine a plurality of offsets #1B or a plurality of offsets #1C. For example, DRX cycle #1 may be a multiple of more than one DRX cycle in a plurality of DRX cycles associated with a plurality of offsets in the set of offsets indicated by DRX configuration #2. In this case, the UE may select one offset from the plurality of offsets. For example, the UE may select an offset from the plurality of offsets which is associated with the maximum DRX cycle among the more than one DRX cycle. For example, the UE may select a maximum offset from the plurality of offsets which is associated with the more than one DRX cycle.

In some embodiments of the present disclosure, DRX configuration #2 may be configured by a higher layer (e.g., the common start offset can be configured by the RRC layer using a parameter such as drx-CommonStartOffset). In some embodiments of the present disclosure, DRX configuration #2 may be predefined in a standard(s). For example, the common start offset, the common slot offset, or both can be predefined as a fixed value such as 0. In some embodiments of the present disclosure, DRX configuration #2 may be indicated by a layer 1 (L1) signal or channel (e.g., carried by a PDCCH or a DCI).

For simplicity, the DRX start offset and DRX slot offset indicated by configuration #1 are hereinafter referred to as DRX start offset #1 and DRX slot offset #1, and the common DRX start offset and common DRX slot offset as determined or predefined above are hereinafter referred to as DRX start offset #2 and DRX slot offset #2.

It should be noted that the DRX cycle (e.g., DRX cycle #1) applied may be the short DRX cycle or long DRX cycle. Persons skilled in the art would understand that no matter which DRX cycle the UE applies, the UE may apply the same principle as described above.

Various embodiments may be employed for determining the starting position of the DRX on-duration timer. The timer value for the DRX on-duration timer indicated by DRX configuration #1 may be applied for discontinuously monitoring the PDCCH.

In some embodiments of the present disclosure, the starting position of the DRX on-duration timer may be determined based on DRX cycle #1 (i.e., the DRX cycle indicated by DRX configuration #1), DRX start offset #2, and one of DRX slot offset #1 and DRX slot offset #2.

For example, the starting subframe number of a DRX cycle may be determined if the system frame number (denoted as “SFN”) and the subframe number (denoted as “subframe number”) satisfy: [(SFN×10)+subframe number] modulo (drx-ShortCycle)=(DRX start offset #2) modulo (drx-ShortCycle) for short DRX cycle; or [(SFN×10)+subframe number] modulo (drx-LongCycle)=(DRX start offset #2) for long DRX cycle. The delay before starting the DRX on-duration timer may be further determined by DRX slot offset #2 or DRX slot offset #1 (if any).

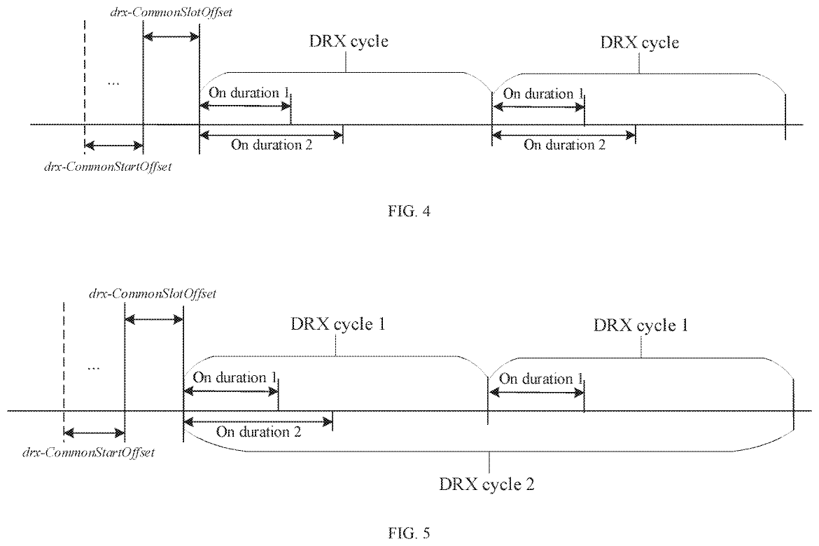

For example, as shown in FIG. 4, a plurality of UEs may determine a common DRX start offset and a common DRX slot offset (respectively denoted as “drx-CommonStartOffset” and “drx-CommonSlotOffset” in FIG. 4) based on DRX configuration #2. For example, the plurality of UEs (e.g., UE #1 and UE #2) may be configured with the same DRX cycle (e.g., by DRX configuration #1). For example, UE #1 may determine the starting position of its on-duration (denoted as “On duration 1” in FIG. 4) based on the DRX cycle, the common DRX start offset, and the common DRX slot offset. The duration of the “On duration 1” may be determined by the time value of a DRX on-duration timer indicated by DRX configuration #1 specific for UE #1. For example, UE #2 may determine the starting position of its on-duration (denoted as “On duration 2” in FIG. 4) based on the DRX cycle, the common DRX start offset, and the common DRX slot offset. The duration of the “On duration 2” may be determined by the time value of a DRX on-duration timer indicated by DRX configuration #1 specific for UE #2.

For example, as shown in FIG. 5, a plurality of UEs (e.g., UE #1A and UE #2A) may determine a common DRX start offset and a common DRX slot offset (respectively denoted as “drx-CommonStartOffset” and “drx-CommonSlotOffset” in FIG. 5) based on DRX configuration #2. For example, UE #1A may be configured with DRX cycle 1 (e.g., by a UE-specific DRX configuration #1), UE #2A may be configured with DRX cycle 2 (e.g., by a UE-specific DRX configuration #1), and DRX cycle 2 is a multiple (e.g., twice) of DRX cycle 1. For example, UE #1A may determine the starting position of its on-duration (denoted as “On duration 1” in FIG. 5) based on DRX cycle 1, the common DRX start offset, and the common DRX slot offset. The duration of the “On duration 1” may be determined by the time value of a DRX on-duration timer indicated by DRX configuration #1 specific for UE #1A. For example, UE #2A may determine the starting position of its on-duration (denoted as “On duration 2” in FIG. 5) based on DRX cycle 2, the common DRX start offset, and the common DRX slot offset. The duration of the “On duration 2” may be determined by the time value of a DRX on-duration timer indicated by DRX configuration #1 specific for UE #2A.

The following embodiments introduce an additional offset of the on-duration in a DRX cycle which can reduce the probability of PDCCH collision.

As mentioned above, a UE may be configured with a set of maximum on-duration timers each associated with a corresponding set of DRX cycles (e.g., by DRX configuration #2). In some embodiments of the present disclosure, the common DRX start offset and common DRX slot offset as determined above may be applied to determine the starting position of the maximum on-duration timer which is associated with the corresponding set of DRX cycles.

For example, the starting position of a maximum on-duration timer of a UE may be determined based on DRX cycle #1 (i.e., the DRX cycle indicated by DRX configuration #1 for the UE), DRX start offset #2, and one of DRX slot offset #1 and DRX slot offset #2. There are respective offsets in the maximum on-duration timer for multiple UEs which share a common offset (e.g., DRX start offset #2 and DRX slot offset #2). For example, the starting position of a DRX on-duration timer for a specific UE of the multiple UEs may be further delayed by an offset from the starting position of the maximum on-duration timer. In some embodiments, such offset may be determined based on a scaling factor and DRX start offset #1.

In some embodiments of the present disclosure, the scaling factor may be based on DRX cycle #1 and the maximum on-duration timer value (denoted as “max duration”) in the set of values for the maximum on-duration timer associated with a set of DRX cycles associated with a common offset (e.g., DRX start offset #2). For example, a factor α can be determined according to ceil/floor/round (DRX cycle #1/max duration) and the offset can be determined according to (DRX start offset #1)/a. In these embodiments, the end point of an on-duration timer of a certain UE of the multiple UEs which share the common offset may exceed the end point of the maximum on-duration timer. In such case, in some examples, the end point of the on-duration timer of UE may be defined as the end point of the maximum on-duration timer. That is, the actual on-duration time of this UE may be shortened. In some examples, the end point of the on-duration timer of UE may not be influenced by the end point of the maximum on-duration timer. That is, the actual on-duration time of this UE may be equal to the configuration timer value.

In some embodiments of the present disclosure, the scaling factor may be based on DRX cycle #1, the timer value for the DRX on-duration timer (e.g., indicated by DRX configuration #1), and the maximum on-duration timer value (i.e., “max duration”) in the set of values for the maximum on-duration timer associated with a set of DRX cycles associated with the common offset (e.g., DRX start offset #2). For example, a factor α′ can be determined according to ceil/floor/round (DRX cycle #1/(max duration-drx-onDurationTimer) and the offset can be determined according to (DRX start offset #1)/a′, wherein “drx-onDurationTimer” denotes the timer value for the DRX on-duration timer indicated by the UE-specific DRX configuration #1. In these embodiments, the end points of the on-duration timers of all of the multiple UEs which share a common offset would not exceed the end point of the maximum on-duration timer.

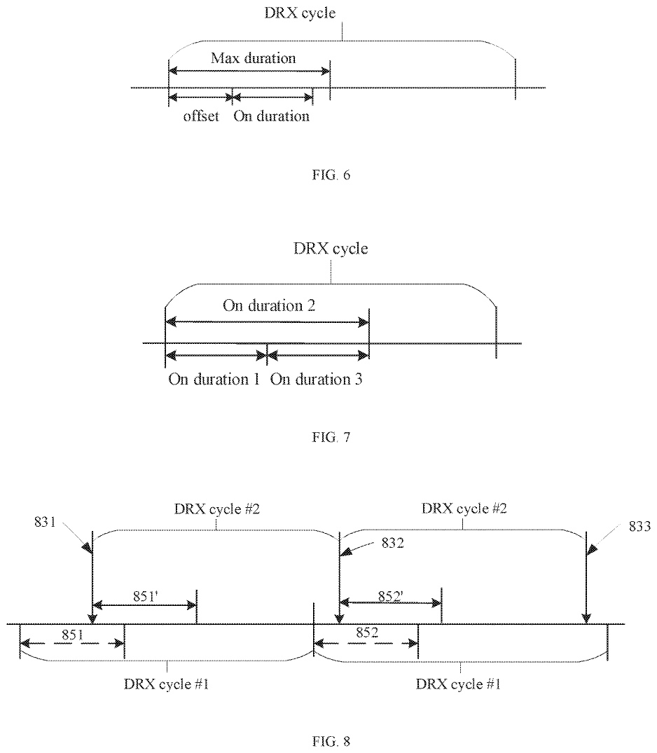

For example, as shown in FIG. 6, a plurality of UEs may determine a common DRX start offset and a common DRX slot offset (not shown in FIG. 6) based on DRX configuration #2. For example, the plurality of UEs (e.g., UE #1B and UE #2B) may be configured with the same DRX cycle (e.g., by DRX configuration #1). For example, UE #1B and UE #2B may determine the starting position of the maximum on-duration timer (denoted as “Max duration” in FIG. 6) based on the DRX cycle, the common DRX start offset and the common DRX slot offset. UE #1B may further determine an offset (denoted as “offset” in FIG. 6) from the starting position of the maximum on-duration timer by scaling the DRX start offset (e.g., DRX start offset #1) configured by UE-specific DRX configuration #1. UE #1B may determine the starting position of its on-duration (denoted as “On duration” in FIG. 6) based on the offset and the starting position of the “Max duration”. UE #1B may determine the offset based on the scaling factor (e.g., scaling factor α or α′ as described above) and DRX start offset #1. The duration of the “On duration” may be determined by the time value of the DRX on-duration timer indicated by DRX configuration #1 specific for UE #1B. UE #2B may perform a similar procedure to determine its on-duration.

In some embodiments of the present disclosure, the starting position of a DRX cycle may be determined based on DRX cycle #1 (i.e., the DRX cycle indicated by DRX configuration #1), DRX start offset #2 and one of DRX slot offset #1 and DRX slot offset #2. There is an offset between the starting position of the DRX cycle and the starting position of the DRX on-duration timer for a UE. For example, the starting position of the DRX on-duration timer for a UE may be further delayed by an offset from the starting position of the DRX cycle. In some embodiments, such offset may be determined based on the UE ID and the timer value for the DRX on-duration timer (e.g., indicated by DRX configuration #1).

For example, denoting M=(UE ID) mod (drx-onDurationTimer), the offset can be determined according to (M×drx-onDurationTimer) in units of ms, wherein “drx-onDurationTimer” denotes the timer value for the DRX on-duration timer indicated by the UE-specific DRX configuration #1.

For example, as shown in FIG. 7, a plurality of UEs may determine a common DRX start offset and a common DRX slot offset (not shown in FIG. 7) based on DRX configuration #2. For example, the plurality of UEs may be configured with the same DRX cycle (e.g., by DRX configuration #1). For example, the plurality of UEs (e.g., UE #1C, UE #2C and UE #3C) may determine the starting position of a DRX cycle based on the configured DRX cycle, the common DRX start offset, and the common DRX slot offset.

In some embodiments, UE #1C and UE #2C may further determine the offsets from the starting position of the DRX cycle to the starting positions of their on-duration timers (respectively denoted as “On duration 1” and “On duration 2” in FIG. 7) being 0. For example, (UE ID of UE #1C) mod (the timer value of “On duration 1”)=0 and (UE ID of UE #2C) mod (the timer value of “On duration 2”)=0. Therefore, as shown in FIG. 7, the starting positions of “On duration 1” and “On duration 2” are the same as that of the DRX cycle. Similarly, UE #3C may determine the offset from the starting position of the DRX cycle to the starting positions of its on-duration timers (denoted as “On duration 3” in FIG. 7).

In some embodiments of the present disclosure, DRX configuration #2 may be cell specific. For example, in embodiments of the present disclosure, DRX configuration #2 (e.g., the DRX associated information) may indicate at least one of: a DRX cycle (denoted as DRX cycle #2), a value for a maximum on-duration timer (denoted as maximum on-duration timer value #2), a DRX start offset (denoted as DRX start offset #2′), or a DRX slot offset (denoted as DRX slot offset #2′). DRX cycle #2 may include a long DRX cycle, a short DRX cycle, or both.

In some embodiments of the present disclosure, the DRX cycle (e.g., long DRX cycle or short DRX cycle) for monitoring the PDCCH (denoted as DRX cycle #3 for simplicity) may be based on DRX cycle #2, or based on DRX cycle #1 (e.g., as indicated by DRX configuration #1) and DRX cycle #2.

For example, in some embodiments, DRX cycle #3 may be equal to DRX cycle #2. For example, in some embodiments, DRX cycle #3 may be determined by scaling DRX cycle #2. For example, DRX cycle #3 may be determined based on a scaling factor and DRX cycle #2, and the scaling factor may be based on DRX cycle #1 and DRX cycle #2.

For example, the scaling factor (denoted as β) may be determined according to β=[max(A, B)/min(A, B)], wherein A and B denote DRX cycle #1 and DRX cycle #2, respectively. In the case that the value of DRX cycle #1 is larger than that of DRX cycle #2, DRX cycle #3 may be equal to β×DRX cycle #2. In the case that the value of DRX cycle #1 is smaller than or equal to that of DRX cycle #2, DRX cycle #3 may be equal to β/1×DRX cycle #2.

The methods for determining the starting position of the DRX on-duration timer for a UE with respect to the UE-group dynamic DRX configuration manner may be similarly applied here, with a modification on the applied parameters.

For example, in some embodiments of the present disclosure, the starting position of the DRX on-duration timer may be determined based on DRX cycle #3, DRX start offset #2′ and one of DRX slot offset #1 and DRX slot offset #2′.

For example, the starting subframe number of a DRX cycle may be determined if the system frame number (denoted as “SFN”) and the subframe number (denoted as “subframe number”) satisfy: [(SFN×10)+subframe number] modulo (DRX cycle #3)=(DRX start offset #2′) modulo (DRX cycle #3) for short DRX cycle; or [(SFN×10)+subframe number] modulo (DRX cycle #3)=(DRX start offset #2′) for long DRX cycle. The delay before starting the DRX on-duration timer may be further determined by DRX slot offset #2′ or DRX slot offset #1 (if any).

As mentioned above, DRX configuration #2 may configure a maximum on-duration timer (e.g., maximum on-duration timer value #2). In some embodiments of the present disclosure, the starting position of the maximum on-duration timer may be determined based on DRX cycle #3, DRX start offset #2′ and one of DRX slot offset #1 and DRX slot offset #2′. There may be respective offsets in the maximum on-duration timer for corresponding UEs in the serving cell. For example, the starting position of a DRX on-duration timer for a specific UE may be further delayed by an offset from the starting position of the maximum on-duration timer. In some embodiments, such offset may be determined based on a scaling factor and DRX start offset #1.

In some embodiments of the present disclosure, the scaling factor may be based on DRX cycle #1 and maximum on-duration timer value #2. For example, a factor α₁ can be determined according to ceil/floor/round (DRX cycle #1/(maximum on-duration timer value #2)) and the offset can be determined according to (DRX start offset #1)/α₁. In these embodiments, the end point of an on-duration timer of a certain UE may exceed the end point of the maximum on-duration timer. In such case, in some examples, the end point of the on-duration timer of UE may be defined as the end point of the maximum on-duration timer. That is, the actual on-duration time of this UE may be shortened. In some examples, the end point of the on-duration timer of UE may not be influenced by the end point of the maximum on-duration timer. That is, the actual on-duration time of this UE may be equal to the configuration timer value.

In some embodiments of the present disclosure, the scaling factor may be based on DRX cycle #1, the timer value for the DRX on-duration timer (e.g., indicated by DRX configuration #1), and maximum on-duration timer value #2. For example, a factor α₁′ can be determined according to ceil/floor/round (DRX cycle #1/(maximum on-duration timer value #2−drx-onDurationTimer) and the offset can be determined according to (DRX start offset #1)/α₁′, wherein “drx-onDurationTimer” denotes the timer value for the DRX on-duration timer indicated by the UE-specific DRX configuration #1. In these embodiments, the end points of the on-duration timers of all UEs in the serving cell would not exceed the end point of the maximum on-duration timer.

In some embodiments of the present disclosure, the starting position of a DRX cycle may be determined based on DRX cycle #3, DRX start offset #2′ and one of DRX slot offset #1 and DRX slot offset #2′. There is an offset between the starting position of the DRX cycle and the starting position of the DRX on-duration timer for a UE. For example, the starting position of the DRX on-duration timer for a UE may be further delayed by an offset from the starting position of the DRX cycle. In some embodiments, such offset may be determined based on the UE ID and the timer value for the DRX on-duration timer (e.g., indicated by DRX configuration #1).

For example, denoting M=(UE ID) mod (drx-onDurationTimer), the offset can be determined according to (M×drx-onDurationTimer) in units of ms, wherein “drx-onDurationTimer” denotes the timer value for the DRX on-duration timer indicated by the UE-specific DRX configuration #1.

In some embodiments of the present disclosure, DRX cycle #3 may be based on DRX cycle #1. For example, DRX cycle #3 may be equal to DRX cycle #1. That is, the DRX cycle (e.g., long DRX cycle or short DRX cycle) for monitoring the PDCCH is DRX cycle #1. That is, long DRX cycle for monitoring the PDCCH is the long DRX cycle in DRX cycle #1 and short DRX cycle for monitoring the PDCCH is the short DRX cycle in DRX cycle #1. The starting position of the DRX on-duration timer for a UE in a DRX cycle may be based on a reference starting position determined based on DRX configuration #2 in the DRX cycle.

In some embodiments, in the case that there are a plurality of reference starting positions in a DRX cycle for monitoring the PDCCH, a predefined (e.g., earliest) reference starting position of the plurality of reference starting positions may be used for determining the starting position of the DRX on-duration timer in the DRX cycle. In some embodiments, in the case that there is no reference starting position in a certain DRX cycle for monitoring the PDCCH, the UE may skip the PDCCH monitoring in this DRX cycle.

For example, referring to FIG. 8, a UE may use DRX cycle #1 for monitoring the PDCCH. Based on DRX configuration #1, the UE may determine DRX cycles #1 and may determine the on-duration (e.g., on-durations 851 and 852) within each DRX cycle #1. For example, the UE may make such determination by referring to the method as described with respect to FIG. 2. The UE may determine DRX cycles #2 based on DRX configuration #2. For example, the UE may make such determination by referring to the method as described with respect to FIG. 2. The UE may then determine reference starting positions 831-833 corresponding to DRX cycles #2 as shown in FIG. 8.

In the example of FIG. 8, since reference starting position 831 is the only reference starting position within the first DRX cycle #1 in FIG. 8, reference starting position 831 may be used to determine the actual starting position of the DRX on-duration timer in the first DRX cycle #1. For example, on-duration 851 may be moved to on-duration 851′. That is, the UE may monitor a PDCCH during on-duration 851′ in the first DRX cycle #1.

Reference starting positions 832 and 833 are located within the second DRX cycle #1 in FIG. 8. In some examples, reference starting position 832 which is earlier in the time domain may be used to determine the actual starting position of the DRX on-duration timer in the second DRX cycle #1. For example, on-duration 852 may be moved to on-duration 852′. That is, the UE may monitor a PDCCH during on-duration 852′ in the second DRX cycle #1.

In some embodiments of the present disclosure, DRX cycle #3 may be based on DRX cycle #1. For example, DRX cycle #3 may be equal to DRX cycle #1. That is, the DRX cycle (e.g., long DRX cycle or short DRX cycle) for monitoring the PDCCH is DRX cycle #1. The actual on-duration for a UE in a DRX cycle may be based on an intersection of an on-duration determined based on DRX configuration #1 and an on-duration determined based on DRX configuration #2. That is, the UE may monitor a PDCCH during a time duration in an on-duration determined based on DRX configuration #1 overlapping with an on-duration determined based on DRX configuration #2.

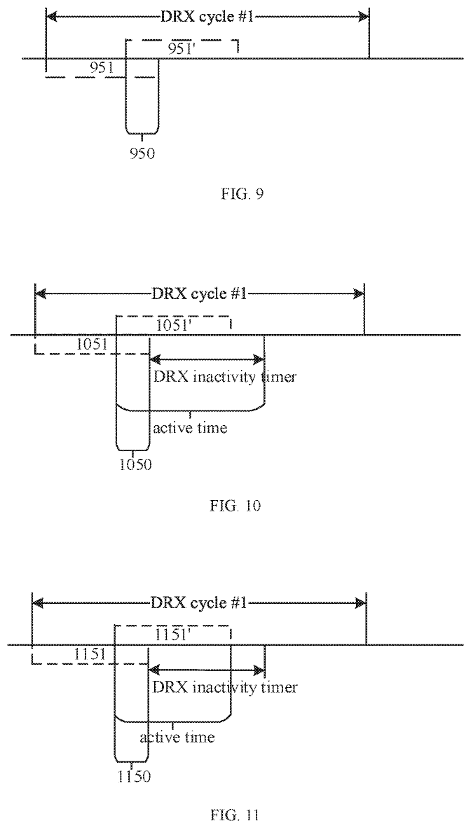

For example, referring to FIG. 9, a UE may use DRX cycle #1 indicated by DRX configuration #1 for monitoring the PDCCH. Based on DRX configuration #1, the UE may determine on-duration 951 within DRX cycle #1. Based on DRX configuration #2, the UE may determine on-duration 951′ within DRX cycle #1. The UE may determine the actual on-duration 950 as the intersection of on-duration 951 and on-duration 951′. For example, the UE may monitor a PDCCH during on-duration 950 in the DRX cycle #1. In the case that configuration #2 does not indicate the timer value for the on-duration timer, on-duration 951′ may be determined further based on the timer value for the on-duration timer as indicated in configuration #1.

In the case that a UE receives a PDCCH in an on-duration (e.g., on-duration 950 in FIG. 9) in a DRX cycle, the active time in the DRX cycle may include another timer(s) (e.g., a DRX inactivity timer as described above with respect to FIG. 3).

In some embodiments of the present disclosure, the timer(s) other than the DRX on-duration timer may not be influenced by DRX configuration #2 (e.g., the on-duration determined by DRX configuration #2 such as on-duration 951′ in FIG. 9). For example, the duration of the DRX inactivity timer is equal to the configured value in DRX configuration #1.

For example, referring to FIG. 10, a UE may use DRX cycle #1 indicated by DRX configuration #1 for monitoring the PDCCH. Based on DRX configuration #1, the UE may determine on-duration 1051 within DRX cycle #1. Based on DRX configuration #2, the UE may determine on-duration 1051′ within DRX cycle #1. The UE may determine the actual on-duration 1050 as the intersection of on-duration 1051 and on-duration 1051′.

In some examples, the UE may receive a PDCCH during on-duration 1050 and may start a DRX inactivity timer in response to receiving the PDCCH. The value of the DRX inactivity timer may be indicated by DRX configuration #1. In the example of FIG. 10, the DRX inactivity timer may expire later than on-duration 1051′. The UE may monitor a PDCCH during the DRX inactivity timer as shown in FIG. 10. Accordingly, as shown in FIG. 10, the active time covers on-duration 1050 and the whole DRX inactivity timer.

In some embodiments of the present disclosure, the timer(s) other than the DRX on-duration timer may be influenced by DRX configuration #2 (e.g., the on-duration determined by DRX configuration #2 such as on-duration 951′ in FIG. 9). For example, the UE may only monitor a PDCCH during the time within the on-duration determined by DRX configuration #2. For example, in the case that the DRX inactivity timer expires at a later time than that of the on-duration determined by DRX configuration #2, the UE may stop monitoring the PDCCH in response to the expiry of the on-duration determined by DRX configuration #2, instead of the expiry of the DRX inactivity timer.

For example, referring to FIG. 11, a UE may use DRX cycle #1 indicated by DRX configuration #1 for monitoring the PDCCH. Based on DRX configuration #1, the UE may determine on-duration 1151 within DRX cycle #1. Based on DRX configuration #2, the UE may determine on-duration 1151′ within DRX cycle #1. The UE may determine the actual on-duration 1150 as the intersection of on-duration 1151 and on-duration 1151′.

In some examples, the UE may receive a PDCCH during on-duration 1150 and may start a DRX inactivity timer in response to receiving the PDCCH. The value of the DRX inactivity timer may be indicated by DRX configuration #1. In the example of FIG. 11, the DRX inactivity timer may expire later than on-duration 1151′. The UE may stop monitoring a PDCCH in response to the expiry of on-duration 1151′, instead of the DRX inactivity timer. That is, as shown in FIG. 11, the active time covers on-duration 1150 and only a part of the DRX inactivity timer. Put another way, the duration of the DRX inactivity timer may be shortened, or the DRX inactivity timer may be stopped in advance.

In some embodiments of the present disclosure, DRX configuration #2 (e.g., the DRX associated information) may include a periodicity of a synchronization signal block (SSB). The DRX cycle (e.g., long DRX cycle or short DRX cycle) for monitoring the PDCCH (e.g., DRX cycle #3) may be associated with the periodicity of the SSB.

For example, DRX cycle #3 may be equal to the SSB periodicity. For example, DRX cycle #3 may be a multiple (e.g., twice, triple, etc.) of the SSB periodicity. For example, DRX cycle #3 may be based on a scaling factor and the SSB periodicity.

For example, the scaling factor (denoted as β′) may be determined according to β′=[max (A′, B′)/min (A′, B′)], wherein A′ and B′ denote DRX cycle #1 indicated by DRX configuration #1 and the SSB periodicity, respectively. In the case that the value of DRX cycle #1 is larger than that of the SSB periodicity, DRX cycle #3 may be equal to β′×SSB periodicity. In the case that the value of DRX cycle #1 is smaller than or equal to that of the SSB periodicity, DRX cycle #3 may be equal to β′/1×SSB periodicity.

In some embodiments of the present disclosure, a DRX on-duration timer in DRX cycle #3 may be associated with a time duration for reception of a synchronization signal (SS) burst set(s). In some examples, an SS burst set may refer to a set of SSBs within a beam sweeping. In some examples, each time duration for reception of an SSB may correspond to a DRX on-duration timer. A SS burst set within an SSB period may be confined within a certain time of the SSB period. For example, an SS burst set may be confined in the first 5 ms within a 20 ms SSB period.

In some embodiments of the present disclosure, a DRX on-duration timer in DRX cycle #3 may be associated with a time duration for reception of an SS burst(s) associated with the same beam as a UE. For example, during a beam sweeping, a BS may transmit beams (e.g., beams #1 to #n) with different directions. A UE may be associated with a beam (e.g., beam #m) with a specific direction when the UE is in a connected mode. The DRX on-duration timer for the UE may be associated with the time duration for receiving an SS burst associated with beam #m.

From the perspective of the network (e.g., a BS), there may S×X on-durations, where S denotes the number of actual transmitted SSBs (e.g., can be determined according to ssb-PositionsInBurst in system information block 1 (SIB1) as specified in 3GPP specifications) and X denotes the number of PDCCH monitoring occasions per an SSB (e.g., nrofPDCCH-MonitoringOccasionPerSSB-InPO as specified in 3GPP specifications) if configured or is equal to 1 otherwise. The [xxS+K]^{th} on-duration may corresponds to the Kt transmitted SSB, where x=0, 1, . . . , X−1, and K=1, 2, . . . , S.

For example, referring to FIG. 12, a UE may be configured with an SSB periodicity. In the example of FIG. 12, it is assumed that the DRX cycle for monitoring the PDCCH is equal to the SSB periodicity. A SS burst set within the SSB periodicity may include SSBs #1 to #4, which may be associated with beams #1 to #4, respectively.

In some embodiments, the DRX on-duration timers in the DRX cycle may be associated with the time duration for reception of the SS burst set within the SSB periodicity. For example, the DRX cycle may include on-durations #1 to #4 (denoted as #1 to #4 in FIG. 12) corresponding to SSBs #1 to #4. That is, the UE may monitor a PDCCH during on-duration #1 to #4 in the DRX cycle.

In some embodiments, the DRX on-duration timers in the DRX cycle may be associated with the time duration for reception of the SS burst(s) associated with the same beam as the UE. For example, assuming that the UE is associated with beam #2, the DRX cycle for the UE may include on-durations #2 (denoted as #2 in FIG. 12) corresponding to SSB #2. That is, the UE may monitor a PDCCH during on-duration #2 in the DRX cycle.

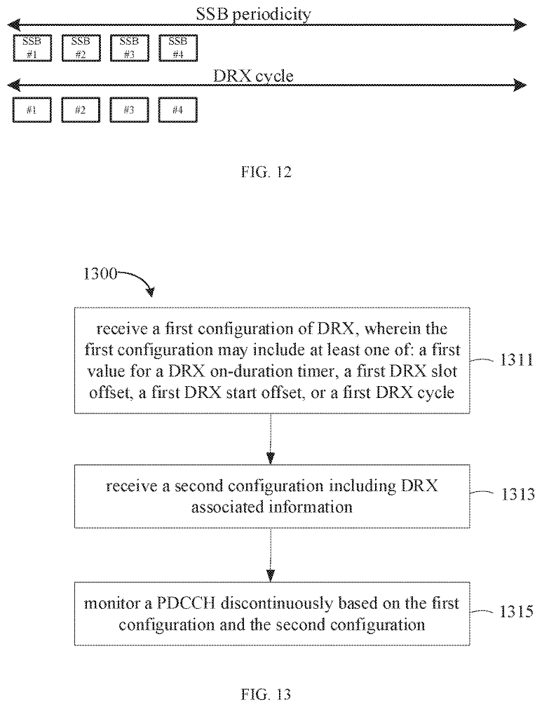

FIG. 13 illustrates a flow chart of an exemplary procedure 1300 for wireless communications in accordance with some embodiments of the present disclosure. Details described in all of the foregoing embodiments of the present disclosure are applicable for the embodiments shown in FIG. 13. In some examples, the procedure may be performed by a UE, for example, UE 101 in FIG. 1.

Referring to FIG. 13, in operation 1311, a UE may receive a first configuration of DRX, wherein the first configuration may include at least one of: a first value for a DRX on-duration timer, a first DRX slot offset, a first DRX start offset, or a first DRX cycle. The descriptions regarding DRX configuration #1 may apply to the first configuration.

In operation 1313, the UE may receive a second configuration including DRX associated information. The descriptions regarding DRX configuration #2 may apply to the second configuration. In operation 1315, the UE may monitor a PDCCH discontinuously based on the first configuration and the second configuration.

In some embodiments of the present disclosure, the DRX associated information may indicate at least one of: a set of offsets or a set of values for a maximum on-duration timer, wherein each offset in the set of offsets is associated with a corresponding set of DRX cycles, and wherein each value in the set of values for the maximum on-duration timer is associated with the corresponding set of DRX cycles.

In some embodiments of the present disclosure, the set of offsets may include a set of start offsets or a set of combinations of a start offset and a slot offset.

In some embodiments of the present disclosure, in response to the first DRX cycle is in a set of DRX cycles associated with a first offset in the set of offsets, or the first DRX cycle is a multiple of a DRX cycle in the set of DRX cycles associated with the first offset, or a DRX cycle in the set of DRX cycles associated with the first offset is a multiple of the first DRX cycle, the UE may determine a second DRX start offset, a second DRX slot offset, or both for monitoring the PDCCH based on the first offset.

In some embodiments of the present disclosure, the DRX associated information may indicate at least one of: a second DRX cycle, a second value for a maximum on-duration timer, a second DRX start offset, or a second DRX slot offset.

In some embodiments of the present disclosure, the UE may determine a third DRX cycle for monitoring the PDCCH based on the second DRX cycle, or based on the first DRX cycle and the second DRX cycle.

In some embodiments of the present disclosure, the third DRX cycle may be determined based on a scaling factor and the second DRX cycle, and the scaling factor is based on the first DRX cycle and the second DRX cycle.

In some embodiments of the present disclosure, the UE may determine a starting position of the DRX on-duration timer based on the first or third DRX cycle, the second DRX start offset, and one of the first DRX slot offset and the second DRX slot offset.

In some embodiments of the present disclosure, the UE may: determine a starting position of the maximum on-duration timer based on the first or third DRX cycle, the second DRX start offset, and one of the first DRX slot offset and the second DRX slot offset; and determine a starting position of the DRX on-duration timer after an offset from the starting position of the maximum on-duration timer. The offset may be based on a scaling factor and the first DRX start offset. In some examples, the scaling factor is based on the first DRX cycle and one of a first maximum on-duration timer value in the set of values for the maximum on-duration timer or the second value for a maximum on-duration timer, wherein the first maximum on-duration timer value is associated with the set of DRX cycles associated with the first offset. In some examples, the scaling factor is based on the first DRX cycle, the first value for the DRX on-duration timer, and one of the first maximum on-duration timer value and the second value for a maximum on-duration timer.

In some embodiments of the present disclosure, the UE may: determine a starting position of a DRX cycle based on the first or third DRX cycle, the second DRX start offset, and one of the first DRX slot offset and the second DRX slot offset; and determine a starting position of the DRX on-duration timer after an offset from the starting position of the DRX cycle. The offset may be based on an ID of the UE and the first value for the DRX on-duration timer.

In some embodiments of the present disclosure, the UE may determine a starting position of the DRX on-duration timer in the first DRX cycle based on a reference starting position determined based on the second configuration in the first DRX cycle. In the case that there are a plurality of reference starting positions in the first DRX cycle, the earliest reference starting position of the plurality of reference starting positions may be used for determining the starting position of the DRX on-duration timer.

In some embodiments of the present disclosure, the UE may determine an on-duration in the first DRX cycle for monitoring the PDCCH based on an intersection of an on-duration determined based on the first configuration and an on-duration determined based on the second configuration.

In some embodiments of the present disclosure, the DRX associated information may include a periodicity of an SSB. Monitoring the PDCCH may include monitoring the PDCCH according to a third DRX cycle associated with the periodicity of the SSB.

In some embodiments of the present disclosure, a DRX on-duration timer in the third DRX cycle is associated with a time duration for reception of an SS burst set(s). In some embodiments of the present disclosure, a DRX on-duration timer in the third DRX cycle is associated with a time duration for reception of an SS burst(s) associated with the same beam as the UE.

In some embodiments of the present disclosure, the third DRX cycle is equal to the periodicity of the SSB, or the third DRX cycle is a multiple of the periodicity of the SSB, or the third DRX cycle is based on a scaling factor and the periodicity of the SSB. The scaling factor may be based on the first DRX cycle and the periodicity of the SSB.

In some embodiments of the present disclosure, monitoring the PDCCH discontinuously based on the first configuration and the second configuration may include one of the following: monitoring the PDCCH discontinuously based on the first configuration and the second configuration in response to receiving the second configuration; or monitoring the PDCCH discontinuously based on the first configuration and the second configuration in response to receiving an indication to activate the second configuration.

It should be appreciated by persons skilled in the art that the sequence of the operations in exemplary procedure 1300 may be changed and some of the operations in exemplary procedure 1300 may be eliminated or modified, without departing from the spirit and scope of the disclosure.

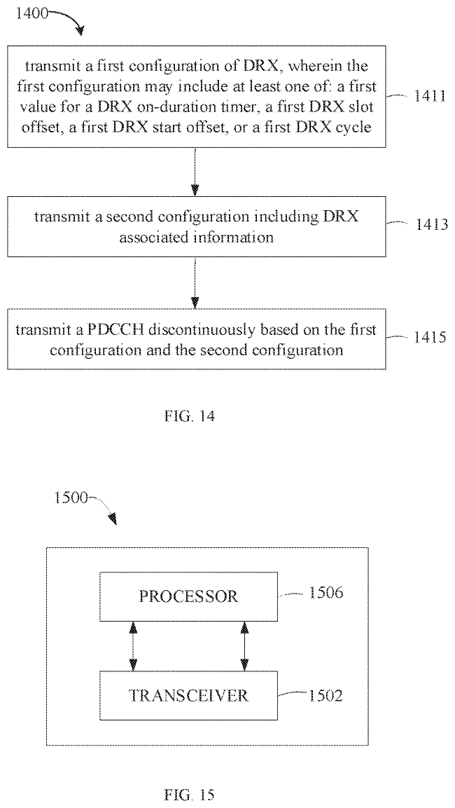

FIG. 14 illustrates a flow chart of an exemplary procedure 1400 for wireless communications in accordance with some embodiments of the present disclosure. Details described in all of the foregoing embodiments of the present disclosure are applicable for the embodiments shown in FIG. 14. In some examples, the procedure may be performed by a BS, for example, BS 102 in FIG. 1.

Referring to FIG. 14, in operation 1411, a BS may transmit, to a UE (e.g., UE 101 in FIG. 1), a first configuration of DRX, wherein the first configuration may include at least one of: a first value for a DRX on-duration timer, a first DRX slot offset, a first DRX start offset, or a first DRX cycle. The descriptions regarding DRX configuration #1 may apply to the first configuration.

In operation 1413, the BS may transmit, to the UE, a second configuration including DRX associated information. The descriptions regarding DRX configuration #2 may apply to the second configuration. In operation 1415, the BS may transmit, to the UE, a PDCCH discontinuously based on the first configuration and the second configuration.

In some embodiments of the present disclosure, the DRX associated information may indicate at least one of: a set of offsets or a set of values for a maximum on-duration timer, wherein each offset in the set of offsets is associated with a corresponding set of DRX cycles, and wherein each value in the set of values for the maximum on-duration timer is associated with the corresponding set of DRX cycles.

In some embodiments of the present disclosure, the set of offsets may include a set of start offsets or a set of combinations of a start offset and a slot offset.

In some embodiments of the present disclosure, in response to the first DRX cycle is in a set of DRX cycles associated with a first offset in the set of offsets, or the first DRX cycle is a multiple of a DRX cycle in the set of DRX cycles associated with the first offset, or a DRX cycle in the set of DRX cycles associated with the first offset is a multiple of the first DRX cycle, the BS may determine a second DRX start offset, a second DRX slot offset, or both for transmitting the PDCCH based on the first offset.

In some embodiments of the present disclosure, the DRX associated information may indicate at least one of: a second DRX cycle, a second value for a maximum on-duration timer, a second DRX start offset, or a second DRX slot offset.

In some embodiments of the present disclosure, the BS may determine a third DRX cycle for transmitting the PDCCH based on the second DRX cycle, or based on the first DRX cycle and the second DRX cycle.

In some embodiments of the present disclosure, the third DRX cycle may be determined based on a scaling factor and the second DRX cycle, and the scaling factor is based on the first DRX cycle and the second DRX cycle.

In some embodiments of the present disclosure, the BS may determine a starting position of the DRX on-duration timer based on the first or third DRX cycle, the second DRX start offset, and one of the first DRX slot offset and the second DRX slot offset.

In some embodiments of the present disclosure, the BS may: determine a starting position of the maximum on-duration timer based on the first or third DRX cycle, the second DRX start offset, and one of the first DRX slot offset and the second DRX slot offset; and determine a starting position of the DRX on-duration timer after an offset from the starting position of the maximum on-duration timer. The offset may be based on a scaling factor and the first DRX start offset. In some examples, the scaling factor is based on the first DRX cycle and one of a first maximum on-duration timer value in the set of values for the maximum on-duration timer or the second value for a maximum on-duration timer, wherein the first maximum on-duration timer value is associated with the set of DRX cycles associated with the first offset. In some examples, the scaling factor is based on the first DRX cycle, the first value for the DRX on-duration timer, and one of the first maximum on-duration timer value and the second value for a maximum on-duration timer.

In some embodiments of the present disclosure, the BS may: determine a starting position of a DRX cycle based on the first or third DRX cycle, the second DRX start offset, and one of the first DRX slot offset and the second DRX slot offset; and determine a starting position of the DRX on-duration timer after an offset from the starting position of the DRX cycle. The offset may be based on an ID of the UE and the first value for the DRX on-duration timer.

In some embodiments of the present disclosure, the BS may determine a starting position of the DRX on-duration timer in the first DRX cycle based on a reference starting position determined based on the second configuration in the first DRX cycle. In the case that there are a plurality of reference starting positions in the first DRX cycle, the earliest reference starting position of the plurality of reference starting positions is used for determining the starting position of the DRX on-duration timer.

In some embodiments of the present disclosure, the BS may determine an on-duration in the first DRX cycle for transmitting the PDCCH based on an intersection of an on-duration determined based on the first configuration and an on-duration determined based on the second configuration.

In some embodiments of the present disclosure, the DRX associated information may include a periodicity of an SSB. Transmitting the PDCCH may include transmitting the PDCCH according to a third DRX cycle associated with the periodicity of the SSB.

In some embodiments of the present disclosure, a DRX on-duration timer in the third DRX cycle is associated with a time duration for reception of an SS burst set(s). In some embodiments of the present disclosure, a DRX on-duration timer in the third DRX cycle is associated with a time duration for reception of an SS burst(s) associated with the same beam as the UE.

In some embodiments of the present disclosure, the third DRX cycle is equal to the periodicity of the SSB, or the third DRX cycle is a multiple of the periodicity of the SSB, or the third DRX cycle is based on a scaling factor and the periodicity of the SSB. The scaling factor may be based on the first DRX cycle and the periodicity of the SSB.

In some embodiments of the present disclosure, transmitting the PDCCH discontinuously based on the first configuration and the second configuration may include one of the following: transmitting the PDCCH discontinuously based on the first configuration and the second configuration in response to transmitting the second configuration; or transmitting an indication to activate the second configuration, and transmitting the PDCCH discontinuously based on the first configuration and the second configuration in response to transmitting the indication.

It should be appreciated by persons skilled in the art that the sequence of the operations in exemplary procedure 1400 may be changed and some of the operations in exemplary procedure 1400 may be eliminated or modified, without departing from the spirit and scope of the disclosure.

FIG. 15 illustrates a block diagram of an exemplary apparatus 1500 according to some embodiments of the present disclosure. As shown in FIG. 15, the apparatus 1500 may include at least one processor 1506 and at least one transceiver 1502 coupled to the processor 1506. The apparatus 1500 may be a UE or a BS.

Although in this figure, elements such as the at least one transceiver 1502 and processor 1506 are described in the singular, the plural is contemplated unless a limitation to the singular is explicitly stated. In some embodiments of the present application, the transceiver 1502 may be divided into two devices, such as a receiving circuitry and a transmitting circuitry. In some embodiments of the present application, the apparatus 1500 may further include an input device, a memory, and/or other components.

In some embodiments of the present application, the apparatus 1500 may be a UE. The transceiver 1502 and the processor 1506 may interact with each other so as to perform the operations with respect to the UE described in FIGS. 1-14. In some embodiments of the present application, the apparatus 1500 may be a BS. The transceiver 1502 and the processor 1506 may interact with each other so as to perform the operations with respect to the BS described in FIGS. 1-14.

In some embodiments of the present application, the apparatus 1500 may further include at least one non-transitory computer-readable medium.

For example, in some embodiments of the present disclosure, the non-transitory computer-readable medium may have stored thereon computer-executable instructions to cause the processor 1506 to implement the method with respect to the UE as described above. For example, the computer-executable instructions, when executed, cause the processor 1506 interacting with transceiver 1502 to perform the operations with respect to the UE described in FIGS. 1-14.

In some embodiments of the present disclosure, the non-transitory computer-readable medium may have stored thereon computer-executable instructions to cause the processor 1506 to implement the method with respect to the BS as described above. For example, the computer-executable instructions, when executed, cause the processor 1506 interacting with transceiver 1502 to perform the operations with respect to the BS described in FIGS. 1-14.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE) for wireless communication, comprising:
at least one memory; and
at least one processor coupled with the at least one memory and configured to cause the UE to:
receive a first configuration of discontinuous reception (DRX), wherein the first configuration comprises at least one of a first value for a DRX on-duration timer, a first DRX slot offset, a first DRX start offset, or a first DRX cycle;
receive a second configuration comprising DRX associated information; and
monitor a physical downlink control channel (PDCCH) discontinuously based on the first configuration and the second configuration.

2. The UE of claim 1, wherein the DRX associated information indicates at least one of a set of offsets or a set of values for a maximum on-duration timer, wherein each offset in the set of offsets is associated with a corresponding set of DRX cycles, and wherein each value in the set of values for the maximum on-duration timer is associated with the corresponding set of DRX cycles.

3. The UE of claim 2, wherein the at least one processor is further configured to cause the UE to:
in response to the first DRX cycle is in a set of DRX cycles associated with a first offset in the set of offsets, or the first DRX cycle is a multiple of a DRX cycle in the set of DRX cycles associated with the first offset, or a DRX cycle in the set of DRX cycles associated with the first offset is a multiple of the first DRX cycle, determine at least one of a second DRX start offset or a second DRX slot offset for monitoring the PDCCH based on the first offset.

4. The UE of claim 1, wherein the DRX associated information indicates at least one of a second DRX cycle, a second value for a maximum on-duration timer, a second DRX start offset, or a second DRX slot offset.

5. The UE of claim 4, wherein the at least one processor is further configured to cause the UE to determine a third DRX cycle for monitoring the PDCCH based on the second DRX cycle, or based on the first DRX cycle and the second DRX cycle.

6. The UE of claim 5, wherein the third DRX cycle is determined based on a scaling factor and the second DRX cycle, and the scaling factor is based on the first DRX cycle and the second DRX cycle.

7. The UE of claim 5, wherein the at least one processor is further configured to cause the UE to determine a starting position of the DRX on-duration timer based on the first DRX cycle or the third DRX cycle, the second DRX start offset, and one of the first DRX slot offset or the second DRX slot offset.

8. The UE of claim 4, wherein the at least one processor is further configured to cause the UE to determine an on-duration in the first DRX cycle for monitoring the PDCCH based on an intersection of an on-duration determined based on the first configuration and an on-duration determined based on the second configuration.

9. The UE of claim 1, wherein the DRX associated information comprises a periodicity of a synchronization signal block (SSB); and
wherein monitoring the PDCCH comprises monitoring the PDCCH according to a third DRX cycle associated with the periodicity of the SSB.

10. The UE of claim 9, wherein a DRX on-duration timer in the third DRX cycle is associated with a time duration for reception of one of one or more synchronization signal (SS) burst sets or one or more SS bursts associated with a same beam as the UE.

11. The UE of claim 9, wherein the third DRX cycle is at least one of equal to the periodicity of the SSB, a multiple of the periodicity of the SSB, or based on a scaling factor and the periodicity of the SSB.

12. The UE of claim 11, wherein the scaling factor is based on the first DRX cycle and the periodicity of the SSB.

13. The UE of claim 1, wherein monitoring the PDCCH discontinuously based on the first configuration and the second configuration comprises the at least one processor configured to cause the UE to monitor the PDCCH discontinuously based on the first configuration and the second configuration in response to receiving one of the second configuration or an indication to activate the second configuration.

14. A base station (BS) for wireless communication, comprising:
at least one memory; and
at least one processor coupled with the at least one memory and configured to cause the BS to:
transmit, to a user equipment (UE), a first configuration of discontinuous reception (DRX), wherein the first configuration comprises at least one of a first value for a DRX on-duration timer, a first DRX slot offset, a first DRX start offset, or a first DRX cycle;
transmit, to the UE, a second configuration comprising DRX associated information; and
transmit, to the UE, a physical downlink control channel (PDCCH) discontinuously based on the first configuration and the second configuration.

15. A method performed by a user equipment (UE), the method comprising:
receiving a first configuration of discontinuous reception (DRX), wherein the first configuration comprises at least one of a first value for a DRX on-duration timer, a first DRX slot offset, a first DRX start offset, or a first DRX cycle;
receiving a second configuration comprising DRX associated information; and
monitoring a physical downlink control channel (PDCCH) discontinuously based on the first configuration and the second configuration.

16. The method of claim 15, wherein the DRX associated information indicates at least one of a set of offsets or a set of values for a maximum on-duration timer, wherein each offset in the set of offsets is associated with a corresponding set of DRX cycles, and wherein each value in the set of values for the maximum on-duration timer is associated with the corresponding set of DRX cycles.

17. The method of claim 16, further comprising:
in response to the first DRX cycle is in a set of DRX cycles associated with a first offset in the set of offsets, or the first DRX cycle is a multiple of a DRX cycle in the set of DRX cycles associated with the first offset, or a DRX cycle in the set of DRX cycles associated with the first offset is a multiple of the first DRX cycle, determining at least one of a second DRX start offset or a second DRX slot offset for monitoring the PDCCH based on the first offset.

18. The method of claim 15, wherein the DRX associated information indicates at least one of a second DRX cycle, a second value for a maximum on-duration timer, a second DRX start offset, or a second DRX slot offset.

19. The method of claim 18, further comprising:
determining a third DRX cycle for monitoring the PDCCH based on the second DRX cycle, or based on the first DRX cycle and the second DRX cycle.

20. A processor for wireless communication, comprising:
at least one controller coupled with at least one memory and configured to cause the processor to:
receive a first configuration of discontinuous reception (DRX), wherein the first configuration comprises at least one of a first value for a DRX on-duration timer, a first DRX slot offset, a first DRX start offset, or a first DRX cycle;
receive a second configuration comprising DRX associated information; and
monitor a physical downlink control channel (PDCCH) discontinuously based on the first configuration and the second configuration.
